(19) United States
(12) Patent Application Publication
(10) Pub. No.: US 2025/0282398 A1
(43) Pub. Date: Sep. 11, 2025

(54) ARRANGEMENT OF A SYSTEM COMPONENT OF A RAIL VEHICLE WITH A PLUG CONNECTION AND RAIL VEHICLE WITH THE ARRANGEMENT

(71) Applicant: KNORR-BREMSE SYSTEME FUR SCHIENENFAHRZEUGE GMBH, Munich (DE)

(72) Inventors: GEZA KATONA, Budapest (HU); Gyorgy VANCSAY, Budapest (HU); Dirk KNOBLOCH, Munich (DE)

(21) Appl. No.: 19/080,879

(22) Filed: Mar. 16, 2025

Related U.S. Application Data
(63) Continuation of application No. PCT/EP2023/073910, filed on Aug. 31, 2023.

(30) Foreign Application Priority Data
Sep. 19, 2022 (DE) 102022123991.8

(51) Int. Cl. B61G 5/10; B61H 5/00; B61L 15/00

(52) U.S. Cl. CPC B61G 5/10; B61L 15/0036; B61H 5/00

(57) ABSTRACT

An arrangement including a system component of a rail vehicle, and a plug connection between the system component of the rail vehicle and the rail vehicle, wherein the plug connection is configured as an intelligent plug connection including a wireless transmission path.

### RELATED APPLICATIONS

This application is a continuation of international patent application PCT/EP2023/073910 filed on Aug. 31, 2023 claiming priority from German application DE 10 2022 123 991.8, filed on Sep. 19, 2022, both of which are incorporated in their entirety by this reference.

### FIELD OF THE INVENTION

The invention relates to an arrangement of a system component of a rail vehicle with an intelligent plug connection (smart plug) according to the preamble of patent claim 1. The invention also relates to a rail vehicle with the arrangement.

### BACKGROUND OF THE INVENTION

An embodiment of a system component of a rail vehicle is a brake caliper. Brake calipers are widely used in brake systems of rail vehicles. They essentially include a force generator which provides an operating force or a spring accumulator force and an adjustment module which compensates wear. Additional components of the brake caliper include a console which facilitates attaching the brake unit in a bogey and a caliper leaver configured to transfer the clamping force to the brake disc and a brake lining carrier including brake linings.

The documents DE 10 2020 124 645 A1 and DE 195 14 463 C1 show embodiments of functions and structures of brake calipers.

Cable plug connectors with the associated sockets are widely used as plug connectors for connecting electrical components of rail vehicle systems.

Installing the plug connectors during initial assembly and maintenance, however, is an additional assembly step in case a system component has to be repaired and replaced. The cable plug connectors require careful handling.

Installing an additional sensor, switch, or similar can require redesign and reconfiguration of the electrical system.

Known wireless solutions can be expanded in a flexible manner and would provide a standardized system solution, but pneumatic system components in rail vehicles typically do not have a separate power connection in addition to the plug connections for sensors and switches. Since an electrical power connection to the pneumatic components has to be installed, the typical wireless solution can be supplemented with batteries or energy generation devices (energy harvesting) which however, require more maintenance and additional installation space.

The term “intelligent plug connection” also includes an “intelligent plug” wherein the intelligent plug connection includes the intelligent plug as well as an associated intelligent socket or an associated intelligent device forming a counter piece for the intelligent plug.

Intelligent plugs (smart plugs) or plug connections are used for wireless data transfer and/or electrical energy transfer. Combinations of wireless and hard wired transmissions are also possible, e.g., signal conductors, control conductors, and/or power conductors can be connected.

Near field communication technology (NFC) is an example of wireless data transmission or communication.

A wireless transmission of electrical energy, e.g., for operating sensors or charging electrical energy accumulators is typically implemented by inductive charging.

Embodiments of inductive charging are described in the document U.S. Pat. No. 6,973,543 B1. The web address https://en.wikipedia.org/wiki/Inductive_charging provides additional principles and embodiments.

### BRIEF SUMMARY OF THE INVENTION

Thus it is an object of the invention to provide and improved arrangement of a system component of a rail vehicle with an intelligent plug connection wherein the disadvantages recited supra are overcome or at least mitigated. It is another object of the invention to provide a rail vehicle including the arrangement.

The object is achieved by the features of patent claim 1.

The object is also achieved by the features of claim 20.

The core idea of the invention is to use an intelligent plug connection (smart plug).

An arrangement according to the invention includes at least one system component of a rail vehicle, including at least one plug connection between the system component of the rail vehicle and the rail vehicle. The at least one plug connection is configured as an intelligent plug connection, including at least one wireless transmission path.

As a particular advantage, a physical configuration of a system including the arrangement is configured much simpler than the prior art.

The physical configuration according to the invention is simpler than the prior art. The arrangement can be upgraded in a quick and simple manner by software updates, e.g., when a new component is added. The physical structure of the arrangement does not have to be changed for this purpose.

It is another advantage of the invention that intelligent plug connectors can process signals from one or plural sensors, switches, and/or other electrical/electronic/electromechanical functional units without physical adjustments.

Thus, it is particularly advantageous that using intelligent plug connections does not require operators to have special knowledge.

Additionally, intelligent plug connections can standardize electrical systems of the rail vehicle which further improves vehicle reliability and availability.

A rail vehicle according to the invention including at least one system component includes in particular at least one arrangement described supra.

In an advantageous embodiment, the at least one intelligent plug connection includes a first transmission unit and a second transmission unit and at least one transmission path and a shielding. This facilitates a simple configuration requiring little installation space.

Advantageously, the at least one wireless transmission path is configured as a bidirectional transmission path. This is advantageous in that not only transferring data in one direction, e.g., from a sensor to a processing unit, but also in the opposite direction is possible. This is advantageous since system upgrades of the sensors, switches, and/or other functional units on a side of the system components can be done in a simpler and quicker manner than in the prior art.

It is another advantage that a pairing of the transmission unit is assured by the position of the ends of the transmission units.

Additional advantageous embodiments are provided in the dependent claims.

In one embodiment the first transmission unit is associated with the system component and connected with sensors, switches, and/or other electronic/electromechanical functional units of the system component by electrically conductive connections hardwired by suitable cables. Thus, advantageously, combinations of advantages of wired solutions and wireless solutions can be achieved.

According to another advantageous embodiment, the first transmission unit is configured to receive electrical energy provided by the second transmission unit through the transmission path to receive data signals of the sensors and/or of the switches of the system component and for a processing and transmission of the received data signals of the sensors, the switches, and/or other electrical/electronic/electromechanical functional units of the system component through the transmission path to the second transmission unit. This is advantageous since not only data but also electrical energy can be transmitted through a common transmission path. The sensors and/or functional units arranged at the system component side can thus be advantageously supplied with electrical energy without having to install an additional energy supply.

In another advantageous embodiment, the first transmission unit is configured to receive data signals of the sensors, the switches, and/or other electrical/electronic/electromechanical functional units of the system component and for transmitting data signals from the second transmission unit in an opposite transmission direction to the sensors, the switches, and/or other electrical/electronic/electromechanical functional units of the system component. Thus, it is advantageously provided that not only data from the sensors and/or the switches of the system component can be captured but also a setting, an update, and/or an adjustment of the sensors and/or of the switches of the system component can be performed by software through the bidirectional transmission path.

According to another advantageous embodiment, the second transmission unit is associated with the rail vehicle and configured to receive data signals of the sensors, the switches and/or other electrical/electronic/electromechanical functional units of the system component transmitted by the first transmission unit through the transmission path and configured to provide electrical energy through the transmission path to the first transmission unit. This advantageously yields a compact configuration with a small number of components.

According to another advantageous embodiment, the second transmission unit is connected with a control unit which provides electrical energy received from the rail vehicle to the second transmission unit and which is configured to receive and process data signals of the sensors, the switches and/or other electrical/electronic/electromechanical functional units of the system component provided by the second transmission unit. This is advantageous since the data signals can be processed with short transmission paths so that a possible external interference is kept to a minimum.

In another advantageous embodiment, the second transmission unit is configured to receive and transmit data signals from the first transmission unit and transmit the data signals to the second transmission unit. Thus, it is advantageous that the second transmission unit facilitates two functions, namely, receiving and transmitting data signals in one unit.

According to another advantageous embodiment, the control unit is hardwired to a control device of the rail vehicle to provide data communication of data signals of the sensors, the switches, and/or other electrical/electronic/electromechanical functional units of the system component and to provide electrical energy, wherein the data signals are provided by the second transmission unit. This advantageously yields a compact configuration.

In another advantageous embodiment, the control device includes processing electronics for received data signals. This advantageously yields a compact configuration.

In another advantageous embodiment, the control unit is connected with the control device of the rail vehicle for data communication through bidirectional connections at interfaces of the control device of the rail vehicle. This advantageously facilitates simple and quick data transmission.

When the control device of the rail vehicle is connected with a bus system of the rail vehicle, this yields the advantage of connecting the intelligent plug connection of the arrangement with the bus system.

In an advantageous embodiment, the first transmission unit and the second transmission unit are configured for wireless communications, e.g., near field communication (NFC) through the transmission path. These are advantageously configured as economical high quality functional units.

Advantageously, the first transmission unit and the second transmission unit are configured for wireless transmission of electrical energy through the transmission path by inductive charging.

In another advantageous embodiment, the first transmission unit, the second transmission unit, and the transmission path are arranged in the shielding. This is advantageous since penetration protection is more robust and much more independent from operating conditions. Additionally, an area of the wireless connections is well-protected against electromagnetic interference, gravel impact, etc. that are quite typical for rail operations.

In another advantageous embodiment, the shielding is configured as a housing, or in the housing or at the housing or additionally arranged in the housing or about the housing. These additional functions yield a compact configuration.

According to an advantageous embodiment, the intelligent plug connection is arranged at an interface between the rail vehicle or between a console or support connected with the rail vehicle and the system component. Advantageously, the required installation space remains unchanged and does not have to be enlarged.

According to another advantageous embodiment, the at least one intelligent plug connection with the at least one wireless transmission path forms an interruption of a galvanic connection between the sensors, switches, and/or other electrical/electronic/electromechanical functional units of the system component of the rail vehicle through connection conductors of the sensors, switches, and/or other electrical/electronic/electromechanical functional units of the system component and the control device of the rail vehicle. This yields the advantage that a possible compensation current between different potentials of the system component of the rail vehicle and the rail vehicle do not run through connection conductors for data and power supply of the sensors, the switches, and/or other electrical/electronic/electromechanical functional units of the system component which could damage these components. Additionally, reduced requirements are placed upon the dielectric strength of the sensors, the switches, and/or other electrical/electronic/electromechanical functional units of the system component.

The arrangement according to the invention has at least the following advantages:
A possible galvanic connection between the bogey and the vehicle body through connection conductors of the sensors, switches, and/or other electrical/electronic/electromechanical functional units of the system component and the control device including processing electronics is interrupted by the wireless transmission path.
Reduced requirements are placed upon the dielectric strength of the switches and/or other electrical/electronic/electromechanical functional units of the system component.
Additional electrical/electronic/electromechanical components and similar of the system component can be arranged in a very simple manner at the brake caliper without additional electrical conductors between the brake caliper of the bogey and the control device with the processing electronics that are run at/in the vehicle body of the rail vehicle wherein the components are capable of cooperating with smart plugs.
Reduction of wiring complexity.
Platform solutions can be reused in follow-on projects without adaptation.

### BRIEF DESCRIPTION OF THE DRAWINGS

An advantageous embodiment of the invention is subsequently described with reference to drawing figures, wherein:

FIG. 1 illustrates a schematic perspective view of an embodiment of an arrangement according to the invention of a system component of a rail vehicle including an intelligent plug connection; and

FIG. 2 illustrates a schematic block diagram including the intelligent plug connection of the embodiment of the arrangement according to the invention according to FIG. 1.

### DETAILED DESCRIPTION OF THE INVENTION

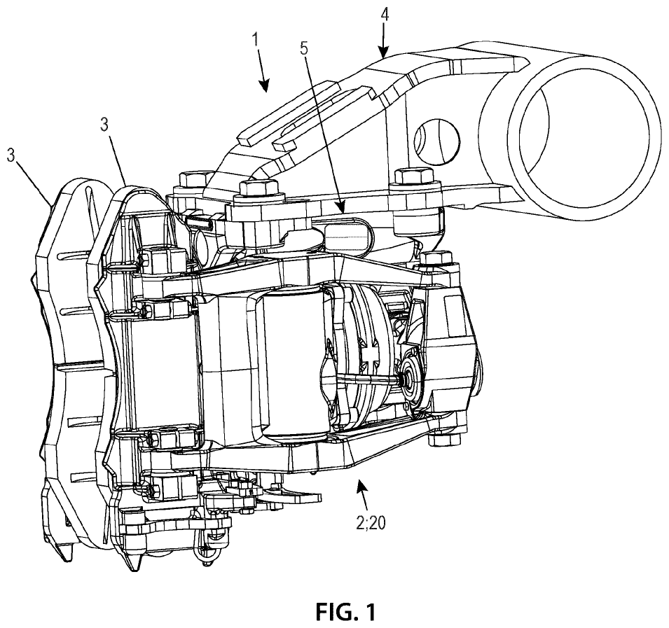

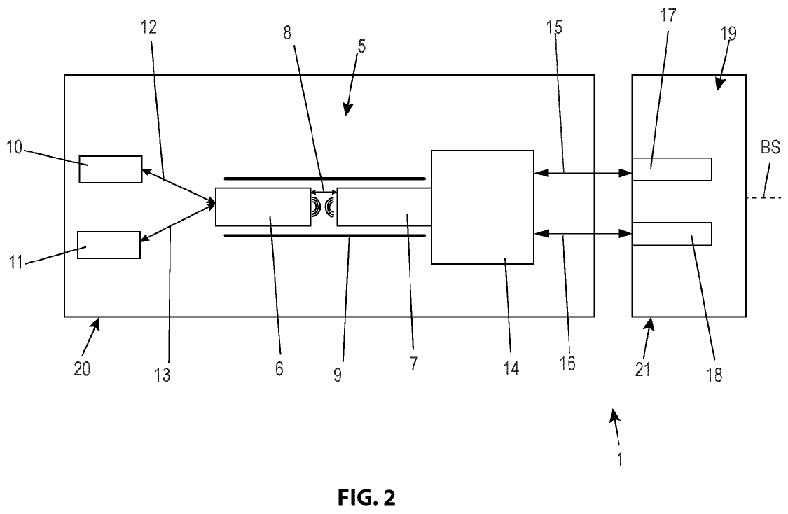

FIG. 1 shows a schematic perspective view of an embodiment of an arrangement 1 according to the invention of a system component 20 of a rail vehicle 21 with an intelligent plug connection or smart plug 5. FIG. 2 illustrates a schematic block diagram with the intelligent plug connection 5 of the embodiment of the arrangement 1 according to the invention according to FIG. 1.

The term intelligent plug connection designates a plug connection that includes an intelligent plug or smart plug as well as the associated intelligent socket.

A brake caliper 2 of a bogey of a rail vehicle 21 is shown as an embodiment of a system component 20 of a rail vehicle 21. The brake caliper is attached at the bogey by a console 4. A configuration and function of exemplary brake calipers 1 are described, e.g., in the documents DE 10 2020 124 645 A1 and DE 195 14 463 C1 which are incorporated in their entirety by this reference.

The brake caliper 1 forms a disc brake for the rail vehicle 21 and includes brake pads that cooperate with a brake disc, e.g., a wheel brake disc or a shaft brake disc.

The intelligent plug connection 5 is arranged at an interface between the rail vehicle 21 or the console 4 connected with the rail vehicle 21 and the brake caliper 2 as a system component 20. Advantageously, the required installation space remains unchanged.

An exemplary intelligent plug connection 5 is shown in FIG. 2 in a schematic block diagram. The intelligent plug connection 5 includes a first transmission unit 6 and a second transmission unit 7 with a common transmission path 8 and a shielding 9.

The transmission units 6, 7, are arranged so that their transmission ends 6a, 7a are arranged at a distance from one another at which the transmission path 8 is fully functional. The transmission ends 6a, 7a can also be arranged closely adjacent to one another. This depends on the properties, in particular, the range, of the transmission units 6, 7.

The transmission units 6, 7 and the transmission path 8 are arranged in the shielding 9. This way, the transmission units 6, 7 and the area of the transmission path 8 are protected against external electromagnetic interference according to electromagnetic compatibility guidelines, wherein electromagnetic radiations by the transmission units 6, 7 themselves and transmission path 8 itself are also prevented. On the other hand side, the shielding 9 also forms a mechanical protection against a penetration of foreign objects and moisture IP protection type and against rock impact which is typical for rail operations.

Since the transmission path 8 is configured wireless, penetration protection (IP protection type) can be configured more robust and independent from operating conditions.

The shielding 9 can also be configured as a housing which provides the protection recited supra and which is also a receiver for the transmission units 6, 7. It is also conceivable that the shielding 9 is arranged in or at the housing or additionally provided in the housing or about the housing.

The first transmission unit 6 is associated with the system component 20. The sensors 10, 11 are connected to the first transmission unit 6 by electrically conductive connections 12, 13, e.g., hardwired through suitable cables. The two illustrated sensors 10, 11 represent a multitude of sensors or switches or other electrical/electronic/electromechanical functional units. Certainly, also, a single sensor 10, 11 and/or a single switch and/or combinations thereof are feasible.

The first transmission unit 6 supplies the sensors 10, 11 with electrical energy and receives data signals of the sensors 10, 11 and/or of the switches. The data signals received by the sensors 10, 11 and the switches are processed by the first transmission unit 6 and transmitted through the transmission path 8 to the second transmission unit 7. This can be performed e.g. by a standardized wireless communication e.g. near field communication (NFC). Other methods are certainly feasible as well.

The transmission path 8 forms a bidirectional transmission path 8 and is thus able to transfer data from the second transmission unit to the first transmission unit 6. This way properties of the sensors 10, 11 and/or the functional units recited supra can be changed, adapted, or provided with an update.

Simultaneously, the first transmission unit 6 is provided with the required electrical energy for the function of the first transmission unit 6 itself as well as for the connected sensors 10, 11 and/or switches through the transmission path 8 by inductive transmission from the second transmission unit 7.

The second transmission unit 7 is connected with a control unit 14. The control unit 14 supplies the second transmission unit 7 with electrical energy and includes signal processing for data transmission.

The second transmission unit 7 receives the data of the sensors 10, 11 through the transmission path 8 and adapts the data for a transfer to a control device 19 of the rail vehicle 21. Thus, the second transmission unit 7 is connected with the control device 19 for the data communication through bidirectional connections 15, 16 at the interfaces 17, 18 of the control device 19. These interfaces 17, 18 can be e.g. typical interfaces with 4-20 mA; 0-10 V or similar.

Additionally, the control unit 14 is connected with the control device 19 for power supply. This power supply operates the control unit 14 on the one hand side and the second transmission unit 7 on the other hand side in order to perform an inductive energy transfer to the first transmission unit 6.

The control device 19 includes processing electronics for the received data signals in this embodiment.

Thus, the control device 19 is connected with a bus system BS of the rail vehicle 21.

The control device 19 additionally includes functional units which generate control signals and data signals configured to control and provide data to the transmission unit 6, 7 and the sensors 10, 11 connected to the first transmission unit 6 and/or the switches and to wirelessly transfer the data through the transmission path 8.

The inductive transmission of electrical energy to provide power to the first transmission unit 6 through the transmission path 8 can also be used simultaneously to transfer data and/or data signals in that the data/data signals is modulated onto the inductive energy transmission.

An application of the intelligent plug connection 5 does not require any special operator skills.

A so-called pairing of the equipment, this means of the sensors 10, 11 and/or the switches and/or functional units at the system component 20 with the intelligent plug connection 5 is assured by a position of the ends of the transmission units 6, 7.

The arrangement 1 with the intelligent plug connection 5 can process one piece of information and/or several pieces of information through the common transmission path 8. The physical configuration is simpler than in the prior art. The arrangement 1 can be upgraded in a quick and simple manner by software updates e.g., when a new component is added, whereas the physical structure of the arrangement 1 does not have to be adjusted for this purpose.

When a sensor 10, 11 or/and an electrical component, e.g. a switch or an electronic functional unit, is arranged at the system component 20 which is a brake caliper 2 of a bogey of a rail vehicle 21 in the illustrated embodiment, this means the functional unit is arranged at the brake caliper, the sensor 10, 11, and/or the electronic component is at the galvanic potential of the bogey.

The control device 19 with the processing electronics is arranged in the vehicle body of the rail vehicle 21 and is thus at the electrical potential of the vehicle body. When there are potential differences between the bogey with the brake caliper 2 configured as the system component 20 and the vehicle body with the processing electronics of the control device 19, a compensation current will flow between the electrical potentials of these two areas. This compensation current will always take the path of least electrical resistance. Sensor conductors and sensors can thus be destroyed when the compensation current runs through them, and even fires can occur when the compensation current runs through an electrical shield in the connection conductor of the sensors 10, 11 and/or electrical components.

In the arrangement 1 described supra, the intelligent plug connection 5 with the wireless transmission path 8 is arranged between the sensors 10, 11 or/and the electrical components of the system component 20 and the processing electronics of the control device 19 of the vehicle body of the rail vehicle 21.

This yields the following advantages when using the intelligent plug connection or smart plug:
A possible galvanic connection between the bogey and the vehicle body through connection conductors of the sensors 10, 11, switches, and/or other electrical/electronic/electromechanical functional units of the system component 20 and the control device 19 including processing electronics is interrupted by the wireless transmission path 8.
Therefore reduced requirements are placed upon the dielectric strength of the sensors 10, 11, and/or other electrical components of the system component.
Additional electrical/electronic/electromechanical components and similar of the system component 20 can be arranged in a very simple manner at the brake caliper 2 without additional electrical conductors between the brake caliper 2 of the bogey and the control device 19 with the processing electronics that are run at/in the vehicle body of the rail vehicle 21, wherein the components are capable of cooperating with intelligent plug connectors or smart plugs.
Platform solutions can be reused in follow-on projects without adaptation.

This advantageously reduces wiring complexity.

A single rail vehicle as well as a train of rail vehicles 21 with the described arrangement 1 includes the intelligent plug connection 5 in the individual rail vehicle 21 as well as in all rail vehicles 21 of a train of rail vehicles. However, also combinations of arrangements 1 with intelligent plug connections 5 as well as with common plug connections are feasible, e.g. when the train of rail vehicles 21 includes vehicles with typical plug connections.

The invention is not limited to the recited embodiments. In particular, individual features of the embodiments can be combined to form additional embodiments within the spirit and scope of the patent claims.

### REFERENCE NUMERALS AND DESIGNATIONS

1 arrangement
2 brake caliper
3 brake pad
4 console
5 intelligent plug connection
6,7 transmission unit
8 transmission path
9 shielding
10, 11 sensor
12, 13 connection
14 control unit
15, 16 connection
17, 18 interface
19 control device
20 system component
21 rail vehicle
BS bus system

What is claimed is:

1. An arrangement, comprising:
a system component of a rail vehicle;
a plug connection between the system component of the rail vehicle and the rail vehicle,
wherein the plug connection is configured as an intelligent plug connection including a wireless transmission path.

2. The arrangement according to claim 1, wherein the intelligent plug connection includes:
a first transmission unit,
a second transmission unit including,
the wireless transmission path, and
a shielding,
wherein the wireless transmission path and the shielding are arranged between the first transmission unit and the second transmission unit.

3. The arrangement according to claim 1, wherein the wireless transmission path is a bidirectional transmission path.

4. The arrangement according to claim 1, wherein the first transmission unit is associated with the system component and connected with sensors, switches, and/or other electrical/electronic/electromechanical functional units of the system component by electrically conductive connections hardwired by accordingly adapted cables.

5. The arrangement according to claim 4,
wherein the first transmission unit is configured to
receive electrical energy provided by the second transmission unit through the wireless transmission path,
receive data signals of the sensors, the switches, and/or other electrical/electronic/electromechanical functional units of the system component through the wireless transmission path, and
process and transmit the received data signals of the sensors, and/or the switches of the system component through the wireless transmission path to the second transmission unit.

6. The arrangement according to claim 5, wherein the first transmission units configured to receive data signals of the sensors, the switches, and/or other electrical/electronic/electromechanical functional units of the system component, and to transmit data signals from the second transmission unit in an opposite transmission direction to the sensors, and/or the switches of the system component.

7. The arrangement according to claim 5, wherein the second transmission unit is associated with the rail vehicle and configured to receive data signals of the sensors, the switches and/or other electrical/electronic/electromechanical functional units of the system component transmitted by the first transmission unit through the transmission path and configured to provide electrical energy through the transmission path to the first transmission unit.

8. The arrangement according to claim 7, wherein the second transmission unit is connected with a control unit which provides electrical energy received from the rail vehicle to the second transmission unit and which is configured to receive and process data signals of the sensors, the switches, and/or other electrical/electronic/electromechanical functional units of the system component provided by the second transmission unit.

9. The arrangement according to claim 8, wherein the second transmission unit is configured to receive and transmit data signals from the first transmission unit and to the first transmission unit.

10. The arrangement according to claim 7, wherein the control unit is hardwired to a control device of the rail vehicle to provide data communication of data signals of the sensors, the switches, and/or other electrical/electronic/electromechanical functional units of the system component and to provide electrical energy, wherein the data signals are provided by the second transmission unit.

11. The arrangement according to claim 10, wherein the control device includes processing electronics for received data signals.

12. The arrangement 1 according to claim 10, wherein the control unit is connected at the control device of the rail vehicle for data communications through bidirectional connections at the interfaces of the control device of the rail vehicle.

13. The arrangement 1 according to claim 10, wherein the control device of the rail vehicle is connected with a bus system of the rail vehicle.

14. The arrangement 1 according to claim 2, wherein the first transmission unit and the second transmission unit are configured for wireless communication or near field communication along the transmission path.

15. The arrangement according to claim 2, wherein the first transmission unit and the second transmission unit are configured to perform wireless transmission of electrical energy through the wireless transmission path by inductive charging.

16. The arrangement 1 according to claim 2, wherein the first transmission unit, the second transmission unit, and the wireless transmission path are arranged in the shielding.

17. The arrangement 1 according to claim 16, wherein the shielding is configured as a housing or the shielding is arranged in or at a housing or additionally in the housing or about the housing.

18. The arrangement 1 according to claim 1, wherein the intelligent plug connection is arranged at an interface between the rail vehicle and the system component, or between a console or support connected with the rail vehicle and the system component.

19. The arrangement according to claim 10, wherein the intelligent plug connection with the wireless transmission path forms an interruption of a galvanic connection between the sensors, switches, and/or other electrical/electronic/electromechanical functional units of the system component of the rail vehicle through connection conductors of the sensors, switches, and/or other electrical/electronic/electromechanical functional units of the system component and the control device of the rail vehicle.

20. A rail vehicle, comprising: the system component configured as the brake caliper, wherein the rail vehicle includes the arrangement according to claim 1.
